(19) United States
(12) Patent Application Publication
(10) Pub. No.: US 2014/0364993 A1
(43) Pub. Date: Dec. 11, 2014

(54) CONTROL METHOD FOR MACHINE TOOL

(71) Applicant: Okuma Corporation, Niwa-Gun (JP)

(72) Inventor: Tetsuya MATSUSHITA, Niwa-Gun (JP)

(73) Assignee: Okuma Corporation, Niwa-Gun (JP)

(21) Appl. No.: 14/259,425

(22) Filed: Apr. 23, 2014

(30) Foreign Application Priority Data
Jun. 10, 2013 (JP) 2013-122113

(51) Int. Cl. G05B 19/402

(52) U.S. Cl. CPC G05B 19/402
USPC 700/193

(57) ABSTRACT

In a control method for a machine tool including two or more translation axes and at least one rotation axis, a command for a distal end position of a tool and an attitude of the tool is provided to correct an error in the distal end position and the attitude with respect to a workpiece due to a geometric error to calculate a command value for controlling the translation axes. The method includes calculating the command value on the basis of a command coordinate value for the distal end position, a converted coordinate value obtained by converting a coordinate value of a rotation center point of the rotation axis in an actual state into a coordinate value without an error in inclination, and an axial unit vector for the ideal rotation axis.

This application claims the benefit of Japanese Patent Application Number 2013-122113 filed on Jun. 10, 2013, the entirety of which is incorporated by reference.

### BACKGROUND OF THE INVENTION

1. Technical Field

The present invention relates to a control method for a machine tool including two or more translation axes and at least one rotation axis, in which a command for a distal end position of a tool and an attitude of the tool is provided to correct an error in the distal end position and the attitude with respect to a workpiece due to a geometric error so that a command value for controlling the translation axes is calculated.

2. Background Art

FIG. 1 is a schematic view of a 5-axis control machining center 1 having three translation axes and two rotation axes as an example of such a machine tool. A spindle head 2 is capable of translation along an X axis and a Z axis with respect to a bed 3. The X axis and the Z axis are translation axes that are orthogonal to each other. A table 4 is capable of rotation about a C axis which is a rotation axis with respect to a cradle 5. The cradle 5 is capable of rotation about an A axis which is a rotation axis with respect to a trunnion 6. The A axis and the C axis are orthogonal to each other. The trunnion 6 is capable of translation along a Y axis with respect to the bed 3. The Y axis is a translation axis that is orthogonal to the X axis and the Z axis. Operation along or about each axis is driven by a servo motor (not illustrated) controlled by a numerical control device. A workpiece is fixed to the table 4. A tool is mounted to the spindle head 2 to be rotated. Machining is performed while controlling the relative position between the workpiece and the tool.

The accuracy of operation of the 5-axis control machining center 5 is affected by, for example, geometric errors between axes such as an error in center position of a rotation axis (deviation from the assumed position) and an error in inclination of a rotation axis (squareness and parallelism between axes). Presence of a geometric error degrades the accuracy of motion of the 5-axis control machining center 1, which degrades the machining accuracy of the workpiece. Therefore, it is necessary to reduce the geometric error through adjustment, although it is difficult to reduce the geometric error to zero. High-accuracy machining is achieved by performing control for correcting the geometric error.

Japanese Patent Application Publication No. 2004-272887 (JP 2004-272887 A) describes a method for correcting a geometric error. According to the method described in JP 2004-272887 A, an error in position of the distal end point of a tool due to a geometric error of a machine tool is corrected by converting the position of the distal end point of the tool into a position of each translation axis in consideration of the geometric error, and using the obtained position as a command position. According to the method described in JP 2004-272887 A, in the case where an error in inclination of a rotation axis is to be corrected, a command for correcting translation axes is provided along with operation of a translation axis. Therefore, operation of only one translation axis may cause infinitesimal operation of another translation axis. For example, in the case where there is an error in parallelism between an X axis and an A axis, operation of only the X axis causes infinitesimal operation of a Y axis or a Z axis.

Such operation may adversely affect the machining accuracy of a planar process and a drilling process. For example, it is assumed that a workpiece 8 is subjected to a planar process by a square end mill (tool) 7 with the direction of the thick arrow P in FIG. 2 defined as the pick direction in the case where the A axis is inclined with respect to the X axis by an angle β as illustrated in FIG. 2 in the 5-axis control machining center 1 of FIG. 1. Then, the distal end point of the tool is determined on a group of points on a line with an inclination 13 with respect to the X axis through correction in the pick direction. That is, determined positions Q are arranged on the line inclined by the inclination β in the pick direction, which may cause steps on the machined surface. In addition, if the infinitesimal operation discussed above is caused in the case where slide guide way is performed along a translation axis, so-called “intermittent feeding” in which the axis occasionally moves and occasionally does not move is caused. As a result, the quality of the machined surface may be degraded. For example, recesses and projections may be formed on the machined surface. Further, in the case where the workpiece 8 is subjected to a drilling process by a drill, rather than the planar process by the square end mill 7, the spindle head 2 is fed in a direction with the inclination β with respect to the Z axis, which is the axial direction of the drill. This may disadvantageously cause an error in hole diameter, and reduce the life of the drill.

Japanese Patent Application Publication No. 2012-221001 (JP 2012-221001 A) describes a method for avoiding such disadvantages. According to the method described in JP 2012-221001 A, a correction value for translation axes are calculated using the coordinate value of a correction reference point that is a point designated in advance in a workpeice coordinate system, and the calculated correction value is added to a command value for the translation axes to obtain a value as a command position in place of the command value for the translation axes. Using the value as the command position, an error in position of the distal end point of a tool due to a geometric error is corrected. According to the method described in JP 2012-221001 A, although the correction value for the translation axes is varied for operation about a rotation axis, the correction value for the translation axes is not varied for operation along a translation axis. Thus, occurrence of slight operation of the translation axes is suppressed, whereby the machining accuracy of the working object is improved.

### SUMMARY OF THE INVENTION

In order to correct an error in position of the distal end point of a tool due to a geometric error while suppressing occurrence of infinitesimal operation of translation axes, it is assumed that the method described in JP 2004-272887 A and the method described in JP 2012-221001 A are performed separately and concurrently. In such a case, however, calculation of a command value for controlling the translation axes may be complicated, which may extend the time required to calculate the command value.

In view of such circumstances, an object of the present invention is to provide a control method for a machine tool that can shorten the time required to calculate a command value for controlling translation axes.

A first aspect of the present invention provides a control method for a machine tool including two or more translation axes and at least one rotation axis. In the method, a command for a distal end position of a tool and an attitude of the tool is provided to correct an error in the distal end position and the attitude with respect to a workpiece due to a geometric error, so that a command value for controlling the translation axes is calculated. The command value is calculated on the basis of a command coordinate value for the distal end position set in advance, a converted coordinate value obtained by converting a coordinate value of a rotation center point of the rotation axis in an actual state with the geometric error into a coordinate value without an error in inclination of the actual rotation axis with respect to the rotation axis in an ideal state without the geometric error using a coordinate value of a correction reference point which is a point designated in advance in a machine coordinate system of the machine tool or a workpiece coordinate system, and an axial unit vector for the ideal rotation axis.

A second aspect of the present invention provides the control method for a machine tool according to the first aspect. In the method, a first intersection calculation step and a first converted coordinate value calculation step are performed. The first intersection calculation step is to calculate an intersection at which a plane that passes through the correction reference point and that is orthogonal to an axial unit vector for the rotation axis that passes through a rotation center point of the ideal rotation axis and an axial unit vector for the rotation axis that passes through a rotation center point of the actual rotation axis crosses each other in the machine coordinate system or the workpiece coordinate system. The first converted coordinate value calculation step is to calculate, as the converted coordinate value, a coordinate value of a projection point obtained by projecting the intersection calculated in the first intersection calculation step onto a plane that passes through the rotation center point of the actual rotation axis and that is orthogonal to an axial unit vector for the rotation axis that passes through the rotation center point of the ideal rotation axis in an axial direction of the ideal rotation axis in the machine coordinate system or the workpiece coordinate system.

A third aspect of the present invention provides the control method for a machine tool according to the first aspect. In the method, a second intersection calculation step and a second converted coordinate value calculation step are performed. The second intersection calculation step is to calculate an intersection at which a plane that passes through the correction reference point and that is orthogonal to an axial unit vector for the rotation axis that passes through a rotation center point of the actual rotation axis and an axial unit vector for the rotation axis that passes through a rotation center point of the actual rotation axis crosses each other in the machine coordinate system or the workpiece coordinate system. The second converted coordinate value calculation step is to calculate, as the converted coordinate value, a coordinate value of a projection point obtained by projecting the intersection calculated in the second intersection calculation step onto a plane that passes through the rotation center point of the actual rotation axis and that is orthogonal to an axial unit vector for the rotation axis that passes through the rotation center point of the ideal rotation axis in an axial direction of the ideal rotation axis in the machine coordinate system or the workpiece coordinate system.

With the control method for a machine tool according to the first aspect of the present invention, when calculating a command value for controlling the translation axes, it is possible to reduce the computation load for calculating the command value by using the command coordinate value for the distal end position of the tool set in advance. Hence, it is possible to shorten the time required to calculate a command value for controlling the translation axes.

According to the second aspect of the present invention, it is possible to calculate the converted coordinate value obtained by converting the coordinate value of the rotation center point of the actual rotation axis into a coordinate value without an error in inclination of the actual rotation axis with respect to the ideal rotation axis, by a simple technique of projecting the intersection calculated in the first intersection calculation step onto a plane that passes through the rotation center point of the actual rotation axis and that is orthogonal to an axial unit vector for the rotation axis that passes through the rotation center point of the ideal rotation axis in the first converted coordinate value calculation step.

According to the third aspect of the present invention, it is possible to calculate the converted coordinate value obtained by converting the coordinate value of the rotation center point of the actual rotation axis into a coordinate value without an error in inclination of the actual rotation axis with respect to the ideal rotation axis, by a simple technique of projecting the intersection calculated in the second intersection calculation step onto a plane that passes through the rotation center point of the actual rotation axis and that is orthogonal to an axial unit vector for the rotation axis that passes through the rotation center point of the ideal rotation axis in the second converted coordinate value calculation step.

### BRIEF DESCRIPTION OF THE DRAWINGS

FIG. 1 is a schematic view of a 5-axis control machining center according to a first embodiment of the present invention.

FIG. 2 is a schematic view of a table etc. of a 5-axis control machining center according to the related art during machining as seen from a direction that is perpendicular to the pick direction.

FIG. 3 is a block line diagram of a numerical control device that performs a control method according to the first embodiment.

FIG. 4 is a flowchart of a process for calculating a command value for translation axes.

FIG. 5 illustrates a method according to the first embodiment for converting the coordinate value of an actual A-axis rotation center point with a geometric error into a coordinate value without the geometric error using a correction reference point.

FIG. 6 is a schematic view of a table etc. of the 5-axis control machining center according to the first embodiment during machining as seen from a direction that is perpendicular to the pick direction.

FIG. 7 illustrates a method according to a second embodiment for converting the coordinate value of an actual A-axis rotation center point with a geometric error into a coordinate value without the geometric error using a correction reference point.

### DETAILED DESCRIPTION OF THE EMBODIMENTS

### First Embodiment

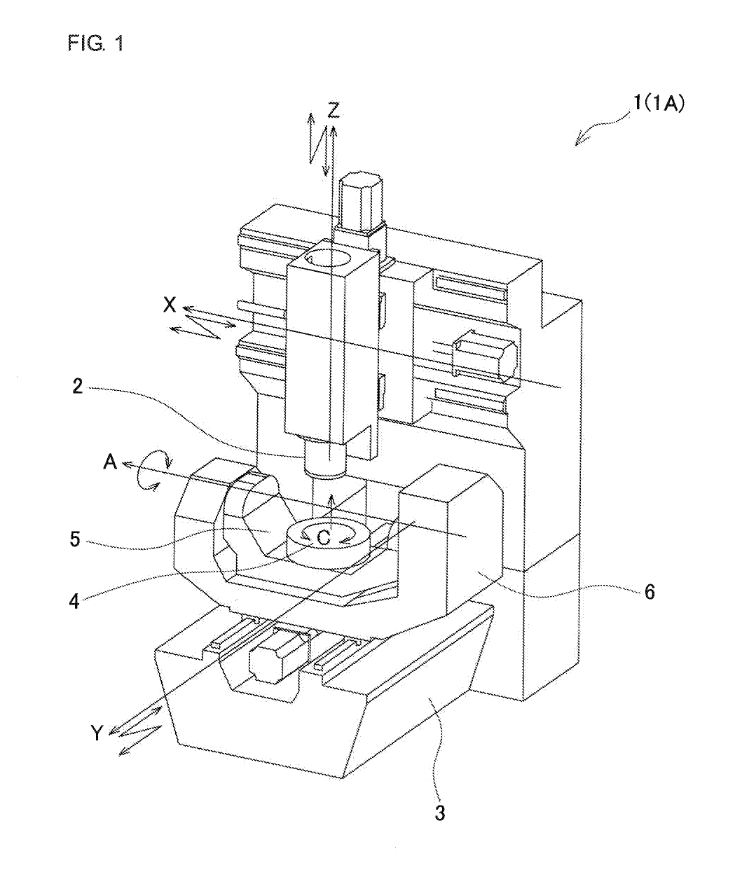

Control for the 5-axis control machining center 1 illustrated in FIG. 1 will be described as an example of a first embodiment of the present invention with reference to FIGS. 1 to 6. The control is performed by a computer that executes a control program. The computer may be a numerical control device for the 5-axis control machining center 1, an independent control device connected to the 5-axis control machining center 1, or a combination of both. The present invention is not limited to the following example, and may be applied to a machine tool with four or less axes or six or more axes, for example. Rather than the table 4 is capable of rotation about two rotation axes, the spindle head 2 may be capable of rotation about two rotation axes, or the spindle head 2 and the table 4 may be capable of rotation about at least one rotation axis each. In addition, the machine tool may be a lathe, a multitasking machine tool, a grinder, or the like in place of a machining center (FIG. 1).

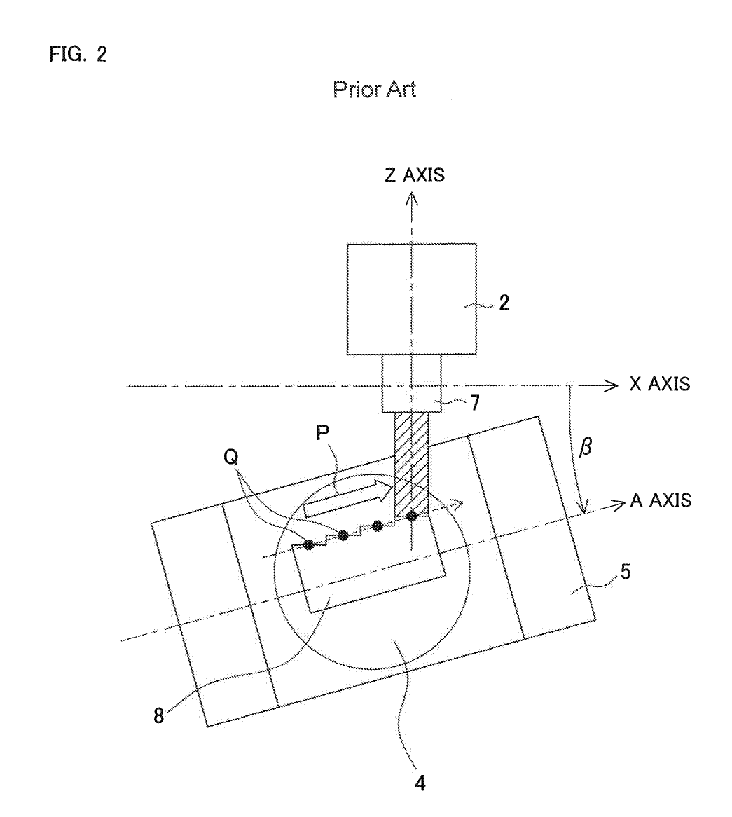

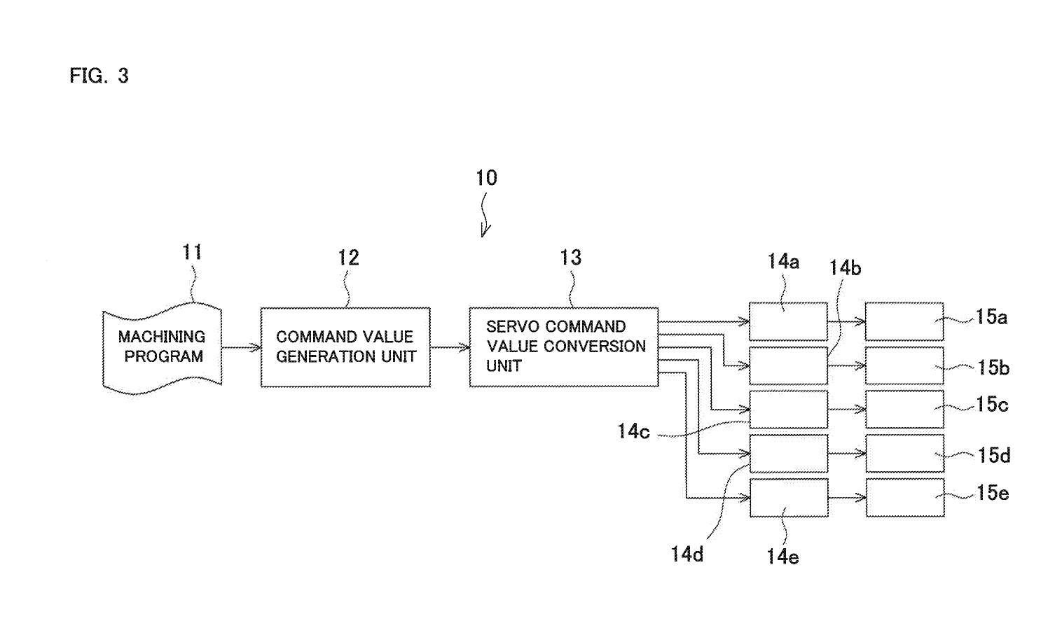

FIG. 3 illustrates an example of a numerical control device 10 that performs the control according to the first embodiment. A command value generation unit 12 generates a command value for each axis (A axis, C axis, X axis, Y axis, Z axis) when a machining program 11 that indicates a command coordinate value for the distal end position of a tool (such as a square end mill 7) is input as a command for moving the tool to a position at which the workpiece 8 (see FIG. 2) is to be machined. The command value is fed to a servo command value conversion unit 13. When the command value is received, the servo command value conversion unit 13 computes servo command values for each axis, and feeds the servo command values to servo amplifiers 14a to 14e for each axis. The servo amplifiers 14a to 14e for each axis drive servo motors 15a to 15e, respectively, and control the relative position and the attitude of the tool mounted to the spindle head 2 with respect to the table 4.

Subsequently, a method for calculating a command value for the translation axes executed by the numerical control device 10 will be described. The numerical control device 10 (command value generation unit 12) can calculate the command value in consideration of geometric parameters that define the status of arrangement of the A axis and the C axis as rotation axes.

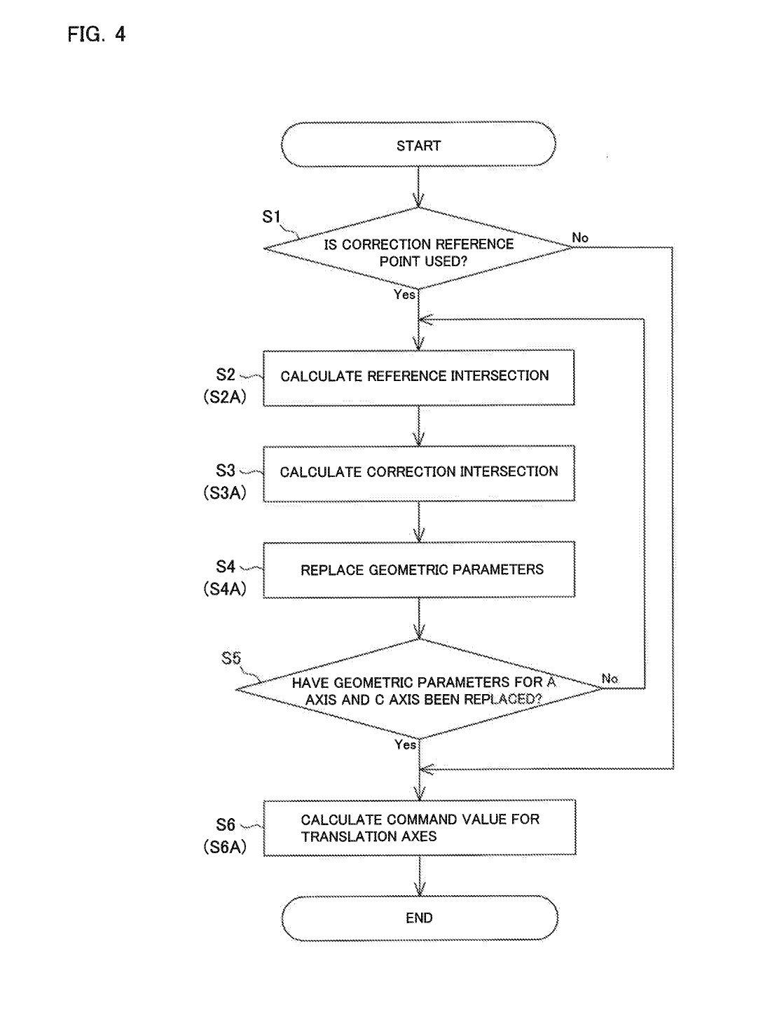

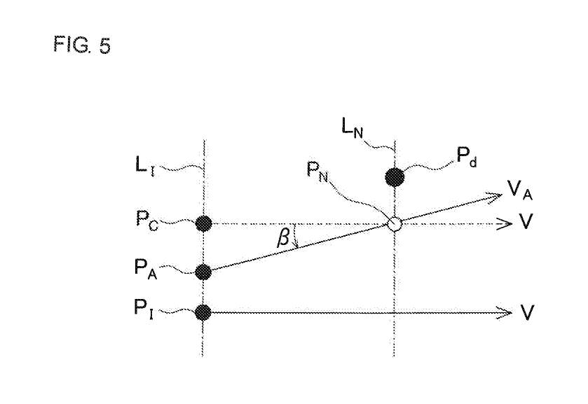

In step S1 of FIG. 4, the command value generation unit 12 determines whether or not a correction reference point Pd is used (see FIG. 5). In the embodiment, an operating section that is provided in the numerical control device 10 and that is operable by an operator can be used to set whether or not the correction reference point Pd is used. The correction reference point Pd may be any point that belongs to the machine coordinate system of the 5-axis control machining center 1. The coordinate value of the correction reference point Pd is in the range of the command value for X axis, Y axis, Z axis, and may be a value set in advance and stored in a storage unit (not illustrated) included in the numerical control device 10 or a value indicated in the machining program 11 or the like.

In the case where it is determined in step S1 that the correction reference point Pd is not used, the command value generation unit 12 calculates a vector Pcmd for a command value (x, y, z) for the translation axes (X axis, Y axis, Z axis) using [Formula 1] in step S6. Using [Formula 1], a command coordinate value (xtcp, ytcp, ztcp) for the distal end position of the tool indicated in the machining program 11 is converted into a coordinate value in the machine coordinate system using a conversion matrix for the A axis (MR2a), a conversion matrix for the C axis (MR1a), and so forth. In this step, the command position (rotational angle) for the A axis is defined as a, the command position (rotational angle) for the C axis is defined as c, the length of the tool used (square end mill 7) is defined as t, the coordinate value of the origin of the machine coordinate system is defined as (xw, yw, zw), the coordinate value of the actual A-axis rotation center point with a geometric error is defined as (xR2a, yR2a, zR2a), the coordinate value of the actual C-axis rotation center point with a geometric error is defined as (xR1a, yR1a, zR1a), the actual A-axis axial unit vector is defined as (λR2a, μR2a, νR2a), and the actual C-axis axial unit vector is defined as (λR1a, μR1a, νR1a).

$$\begin{matrix}{P}_{cmd} = {M}_{t} \cdot {M}_{D 2 a} \cdot {M}_{R 2 a}^{- 1} \cdot {M}_{D 2 a}^{- 1} \cdot {M}_{D 1 a} \cdot {M}_{R 1 a}^{- 1} \cdot {M}_{D 1 a}^{- 1} \cdot {M}_{W} \cdot {P}_{tcp} \\ where \\ {P}_{tcp} = [ \begin{matrix}{x}_{tcp} \\ {y}_{tcp} \\ {z}_{tcp} \\ 1\end{matrix} ] , {P}_{cmd} = [ \begin{matrix}x \\ y \\ z \\ 1\end{matrix} ] , {M}_{W} = [ \begin{matrix}1 & 0 & 0 & {x}_{w} \\ 0 & 1 & 0 & {y}_{w} \\ 0 & 0 & 1 & {z}_{w} \\ 0 & 0 & 0 & 1\end{matrix} ] , \\ {M}_{t} = [ \begin{matrix}1 & 0 & 0 & 0 \\ 0 & 1 & 0 & 0 \\ 0 & 0 & 1 & t \\ 0 & 0 & 0 & 1\end{matrix} ] , & [ Formula 1 ] \\ {M}_{R 1 a} = [ \begin{matrix}cos c + {λ}_{R 1 a}^{2} ( 1 - cos c ) & \begin{matrix}{λ}_{R 1 a} {μ}_{R 1 a} ( 1 - cos c ) - \\ {v}_{R 1} sin c\end{matrix} & \begin{matrix}{v}_{R 1 a} {λ}_{R 1 a} ( 1 - cos c ) + \\ {μ}_{R 1 a} sin c\end{matrix} & 0 \\ \begin{matrix}{λ}_{R 1 a} {μ}_{R 1 a} ( 1 - cos c ) + \\ {v}_{R 1 a} sin c\end{matrix} & cos c + {μ}_{R 1 a}^{2} ( 1 - cos c ) & \begin{matrix}{μ}_{R 1 a} {v}_{R 1 a} ( 1 - cos c ) - \\ {λ}_{R 1 a} sin c\end{matrix} & 0 \\ \begin{matrix}{v}_{R 1 a} {λ}_{R 1 a} ( 1 - cos c ) + \\ {μ}_{R 1 a} sin c\end{matrix} & \begin{matrix}{μ}_{R 1 a} {v}_{R 1 a} ( 1 - cos c ) + \\ {λ}_{R 1 a} sin c\end{matrix} & cos c + {v}_{R 1 a}^{2} ( 1 - cos c ) & 0 \\ 0 & 0 & 0 & 1\end{matrix} ] , & \\ {M}_{R 2 a} = [ \begin{matrix}cos a + {λ}_{R 2 a}^{2} ( 1 - cos a ) & \begin{matrix}{λ}_{R 2} {μ}_{R 2 a} ( 1 - cos a ) - \\ {v}_{R 2 a} sin a\end{matrix} & \begin{matrix}{v}_{R 2 a} {λ}_{R 2 a} ( 1 - cos a ) + \\ {μ}_{R 2 a} sin a\end{matrix} & 0 \\ \begin{matrix}{λ}_{R 2} {μ}_{R 2 a} ( 1 - cos a ) + \\ {v}_{R 2} sin a\end{matrix} & cos a + {μ}_{R 2 a}^{2} ( 1 - cos a ) & \begin{matrix}{μ}_{R 2 a} {v}_{R 2 a} ( 1 - cos a ) - \\ {λ}_{R 2 a} sin a\end{matrix} & 0 \\ \begin{matrix}{v}_{R 2 a} {λ}_{R 2 a} ( 1 - cos a ) - \\ {μ}_{R 2 a} sin a\end{matrix} & \begin{matrix}{μ}_{R 2 a} {v}_{R 2 a} ( 1 - cos a ) + \\ {λ}_{R 2 a} sin a\end{matrix} & cos a + {v}_{R 2 a}^{2} ( 1 - cos a ) & 0 \\ 0 & 0 & 0 & 1\end{matrix} ] , & \\ {M}_{D 1 a} = [ \begin{matrix}1 & 0 & 0 & {x}_{R 1 a} \\ 0 & 1 & 0 & {y}_{R 1 a} \\ 0 & 0 & 1 & {z}_{R 1 a} \\ 0 & 0 & 0 & 1\end{matrix} ] , {M}_{D 2 a} = [ \begin{matrix}1 & 0 & 0 & {x}_{R 2 a} \\ 0 & 1 & 0 & {y}_{R 2 a} \\ 0 & 0 & 1 & {z}_{R 2 a} \\ 0 & 0 & 0 & 1\end{matrix} ] & \end{matrix}$$

On the other hand, in the case where the command value generation unit 12 determines in step S1 that the correction reference point Pd is used, a reference intersection PN (see FIG. 5) is calculated as described below in step S2. In step S2, a plane LN illustrated in FIG. 5 is defined in the machine coordinate system. The plane LN is a plane that passes through the correction reference point Pd and that is orthogonal to an axial unit vector V for the A axis in an ideal state that passes through a rotation center point PI of the ideal A axis without a geometric error. Subsequently, in step S2, an axial unit vector VA (see FIG. 5) for the A axis in an actual state that passes through a rotation center point PA of the actual A axis with a geometric error is defined in the machine coordinate system. Then, a point at which the plane LN and the axial unit vector VA cross each other is defined as the reference intersection PN. In this step, the coordinate value of the correction reference point is defined as (xd, yd, zd), the ideal A-axis axial unit vector V is defined as (1, 0, 0), the coordinate value of the actual A-axis rotation center point PA is defined as (xR2a, yR2a, zR2a), and the actual A-axis axial unit vector VA is defined as (λR2a, μR2a, νR2a). Then, the command value generation unit 12 calculates the coordinate value (xN, yN, zN) of the reference intersection PN using [Formula 2]. Step S2 is an example of the first intersection calculation step according to the present invention.

x_{N}=x_{d} [Formula 2]

y_{N}=y_{R2a}+(x_{d}−x_{R2a})μ_{R2a}/λ_{R2a}

z_{N}=z_{R2a}+(x_{d}−x_{R2a})v_{R2a}/λ_{R2a}

After step S2, the command value generation unit 12 calculates a correction intersection PC (see FIG. 5) as described below in step S3. In step S3, a plane LI illustrated in FIG. 5 is defined in the machine coordinate system. The plane LI is a plane that passes through the actual A-axis rotation center point PA and that is orthogonal to the ideal A-axis axial unit vector V which passes through the ideal A-axis rotation center point PI. Subsequently, in step S3, a point (projection point) obtained by projecting the reference intersection PN defined in step S2 onto the plane LI in the axial direction of the ideal A axis (left-right direction of FIG. 5) is defined as the correction intersection PC. The command value generation unit 12 calculates the coordinate value (xC, yC, zC) of the correction intersection PC using [Formula 3]. If the correction intersection PC is defined as illustrated in FIG. 5, the coordinate value (xC, yC, zC) of the correction intersection PC on the plane LI is obtained by converting the coordinate value (xR2a, yR2a, zR2a) of the actual A-axis rotation center point PA into a coordinate value without an error in inclination (angle β) of the actual A axis with respect to the ideal A axis (i.e. in the case of the actual A axis parallel to the ideal A axis). Step S3 is an example of the first converted coordinate value calculation step according to the present invention. The coordinate value (xC, yC, zC) of the correction intersection PC is an example of the converted coordinate value according to the present invention.

x_{C}=x_{R2a} [Formula 3]

y_{C}=y_{N}

z_{C}=z_{N}

After step S3, the command value generation unit 12 replaces geometric parameters that define the status of arrangement of the A axis in step S4. In step S4, the coordinate value (xR2a, yR2a, zR2a) of the actual A-axis rotation center point in [Formula 1], which is a geometric parameter, is replaced with the coordinate value (xC, yC, zC) of the correction intersection Pc calculated in step S3. In addition, the actual A-axis axial unit vector (λR2a, μR2a, νR2a) in [Formula 1], which is a geometric parameter, is replaced with the ideal A-axis axial unit vector V (1, 0, 0).

After step S4, the command value generation unit 12 determines whether or not geometric parameters that define the status of arrangement have been replaced not only for the A axis but also for the C axis in step S5. In the case where it is determined in step S5 that the geometric parameters have been replaced only for the A axis and that the geometric parameters have not been replaced for the C axis, the command value generation unit 12 executes the processes in step S2 to step S4 also for the C axis in the same manner as for the A axis. Since the processes in step S2 to step S4 are the same for the A axis and the C axis, the processes for the C axis are not described.

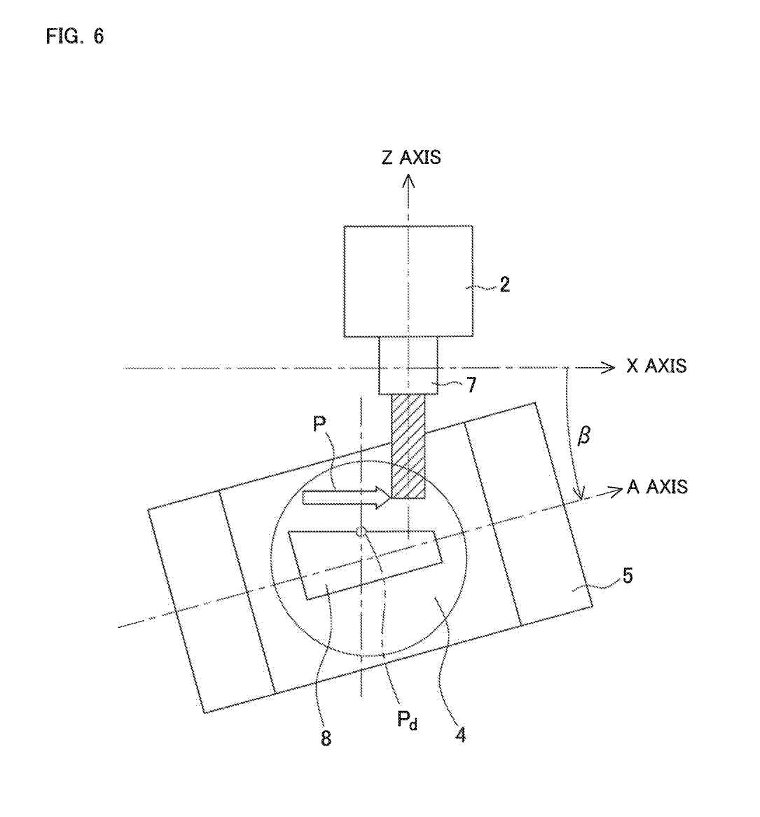

On the other hand, in the case where it is determined in step S5 that the geometric parameters have been replaced for the A axis and the C axis, the command value generation unit 12 calculates a vector Pcmd for a command value (x, y, z) for the translation axes (X axis, Y axis, Z axis) in step S6. In step S6, a command value (x, y, z) for the translation axes is calculated using [Formula 1] in which the geometric parameters for the A axis and the C axis have been replaced in step S4. The relative position of the spindle head 2 with respect to the table 4 is controlled on the basis of the command value (x, y, z). At this time, if the coordinate value (xC, yC, zC) of the correction intersection PC, which is used to calculate a command value (x, y, z) for the translation axes, is used as a coordinate value without an error in inclination (angle 13) of the actual A axis with respect to the ideal A axis, the distal end point of the square end mill 7 can be positioned on a line that is parallel to the X axis in the pick direction (P direction) illustrated in FIG. 6. Hence, unlike the example according to the related art illustrated in FIG. 2, it is possible to prevent steps being formed on the machined surface of the workpiece 8 when the workpiece 8 is subjected to a planar process by the square end mill 7, since the square end mill 7 does not move in the Z-axis direction.

### Effects of First Embodiment

With the control method for the 5-axis control machining center 1 according to the embodiment, when calculating a command value for controlling the translation axes (X axis, Y axis, Z axis), it is possible to reduce the computation load for calculating the command value by using the command coordinate value (xtcp, ytcp, ztcp) for the distal end position of the tool indicated in the machining program 11. Hence, it is possible to shorten the time required to calculate a command value for controlling the translation axes.

In addition, it is possible to convert the coordinate value (xR2a, yR2a, zR2a) of the actual A-axis rotation center point PA into a coordinate value without an error in inclination (angle β) of the actual A axis with respect to the ideal A axis by a simple technique of projecting the reference intersection PN calculated in step S2 illustrated in FIG. 4 onto the plane LI in the axial direction of the ideal A axis (left-right direction of FIG. 5) in step S3.

### Second Embodiment

A second embodiment of the present invention will be described with reference to FIGS. 1, 4, and 7. Differences from the first embodiment will be mainly described herein. In the embodiment, processes in step S2A, step S3A, step S4A, and step S6A of FIG. 4 are different from those in the first embodiment.

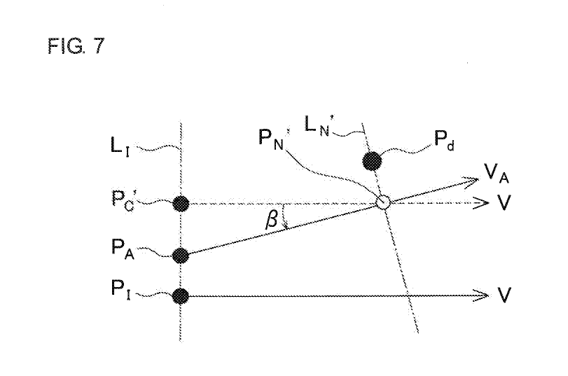

In step S2A, as illustrated in FIG. 7, an actual A-axis axial unit vector VA that passes through an actual A-axis rotation center point PA with a geometric error is defined in the machine coordinate system of a 5-axis control machining center 1A. Subsequently, in step S2A, a plane LN′ is defined in the machine coordinate system. The plane LN′ is a plane that passes through the correction reference point Pd and that is orthogonal to the axial unit vector VA. Then, a point at which the axial unit vector VA and the plane LN′ cross each other is defined as a reference intersection PN′. The command value generation unit 12 calculates a coordinate value (xN′, yN′, zN′) of the reference intersection PN′ using [Formula 4]. Step S2A is an example of the second intersection calculation step according to the present invention.

x_{N}′=λ_{R2a}²(x_{d}−x_{R2a})+μ_{R2a}(y_{d}−y_{R2a})+v_{R2a}(z_{d}−z_{R2a})+x_{R2a} [Formula 4]

y_{N}′=λ_{R2a}(x_{d}−x_{R2a})+μ_{R2a}²(y_{d}−y_{R2a})+v_{R2a}(z_{d}−z_{R2a})+y_{R2a}

z_{N}′=λ_{R2a}(x_{d}−x_{R2a})+μ_{R2a}(y_{d}−y_{R2a})+v_{R2a}²(z_{d}−z_{R2a})+z_{R2a}

After step 2A, a correction intersection PC′ is calculated in step S3A. In step S3A, a plane LI is defined in the machine coordinate system in the same manner as in the first embodiment. Subsequently, in step S3A, a point (projection point) obtained by projecting the reference intersection PN′ defined in step S2A onto the plane LI in the axial direction of the ideal A axis (left-right direction of FIG. 7) without a geometric error is defined as the correction intersection PC′. The command value generation unit 12 calculates a coordinate value (xC′, yC′, zC′) of the correction intersection PC′ using [Formula 5]. If the correction intersection PC′ is defined as illustrated in FIG. 7, the coordinate value (xC′, yC′, zC′) of the correction intersection PC′ on the plane LI is obtained by converting the coordinate value (xR2a, yR2a, zR2a) of the actual A-axis rotation center point PA into a coordinate value without an error in inclination (angle β) of the actual A axis with respect to the ideal A axis. Step S3A is an example of the second converted coordinate value calculation step according to the present invention. The coordinate value (xC′, yC′, zC′) of the correction intersection PC′ is an example of the converted coordinate value according to the present invention.

x_{C}′=x_{R2a} [Formula 5]

y_{C}′=y_{N}′

z_{C}′=z_{N}′

After step S3A, the command value generation unit 12 replaces geometric parameters that define the status of arrangement of the A axis in step S4A. In step S4A, the coordinate value (xR2a, yR2a, zR2a) of the actual A-axis rotation center point in [Formula 1] is replaced with the coordinate value (xC′, yC′, zC′) of the correction intersection PC′ calculated in step S3A. In addition, the actual A-axis axial unit vector (λR2a, μR2a, νR2a) in [Formula 1] is replaced with the ideal A-axis axial unit vector V (1, 0, 0).

In step S6A, a vector Pcmd for a command value (x, y, z) for the translation axes (X axis, Y axis, Z axis) is calculated. In this step, a command value (x, y, z) for the translation axes is calculated using [Formula 1] in which the geometric parameters for the A axis and the C axis have been replaced in step S4A. If the relative position of the spindle head 2 with respect to the table 4 is controlled on the basis of the command value (x, y, z), it is possible to prevent formation of steps on the machined surface of the workpiece 8 when the workpiece 8 is subjected to a planar process in the same manner as in the first embodiment. In the embodiment, the processes in step S2A to step S4A are executed also for the C axis in the same manner as for the A axis. Since the processes in step S2A to step S4A are the same for the A axis and the C axis, the processes for the C axis are not described.

### Effects of Second Embodiment

With the control method for the 5-axis control machining center 1A according to the embodiment, it is possible to convert the coordinate value (xR2a, yR2a, zR2a) of the actual A-axis rotation center point PA into a coordinate value without an error in inclination (angle β) of the actual A axis with respect to the ideal A axis, by a simple technique of projecting the reference intersection PN′ calculated in step S2A illustrated in FIG. 4 onto the plane LI in the axial direction of the ideal A axis (left-right direction of FIG. 7).

The present invention is not limited to the embodiments discussed above, and part of the configuration of the embodiments may be modified appropriately without departing from the scope and spirit of the present invention. In the first and second embodiments discussed above, the coordinate value of the rotation center point of the actual rotation axes (A axis and C axis) is converted into a coordinate value without an error in inclination of the actual rotation axis with respect to the ideal rotation axis with the correction reference point Pd set to any point that belongs to the machine coordinate system. However, the present invention is not limited thereto. For example, the coordinate value of the rotation center point of the actual rotation axes may be converted into a coordinate value without an error in inclination with the correction reference point Pd set to any point that belongs to the workpiece coordinate system near the machining point of the workpiece 8 as indicated by the dash-double-dot line in FIG. 6 so that the correction reference point Pd is movable on the workpiece coordinate system along with operation of a rotation axis. This allows the workpiece 8 to be machined with a geometric error corrected with sufficient accuracy near the correction reference point Pd even if indexing is performed by various angles.

What is claimed is:

1. A control method for a machine tool including two or more translation axes and at least one rotation axis, in which a command for a distal end position of a tool and an attitude of the tool is provided to correct an error in the distal end position and the attitude with respect to a workpiece due to a geometric error so that a command value for controlling the translation axes is calculated, the method comprising:
calculating the command value on the basis of:
a command coordinate value for the distal end position set in advance;
a converted coordinate value obtained by converting a coordinate value of a rotation center point of the rotation axis in an actual state with the geometric error into a coordinate value without an error in inclination of the actual rotation axis with respect to the rotation axis in an ideal state without the geometric error, using a coordinate value of a correction reference point which is a point designated in advance in a machine coordinate system of the machine tool or a workpiece coordinate system; and
an axial unit vector for the ideal rotation axis.

2. The control method for a machine tool according to claim 1, comprising performing:
a first intersection calculation step of calculating an intersection at which a plane that passes through the correction reference point and that is orthogonal to an axial unit vector for the ideal rotation axis that passes through a rotation center point of the ideal rotation axis and an axial unit vector for the actual rotation axis that passes through a rotation center point of the actual rotation axis crosses each other in the machine coordinate system or the workpiece coordinate system; and
a first converted coordinate value calculation step of calculating, as the converted coordinate value, a coordinate value of a projection point obtained by projecting the intersection calculated in the first intersection calculation step onto a plane that passes through the rotation center point of the actual rotation axis and that is orthogonal to an axial unit vector for the ideal rotation axis that passes through the rotation center point of the ideal rotation axis in an axial direction of the ideal rotation axis in the machine coordinate system or the workpiece coordinate system.

3. The control method for a machine tool according to claim 1, comprising performing:
a second intersection calculation step of calculating an intersection at which a plane that passes through the correction reference point and that is orthogonal to an axial unit vector for the rotation axis that passes through a rotation center point of the actual rotation axis and an axial unit vector for the rotation axis that passes through a rotation center point of the actual rotation axis crosses each other in the machine coordinate system or the workpiece coordinate system; and
a second converted coordinate value calculation step of calculating, as the converted coordinate value, a coordinate value of a projection point obtained by projecting the intersection calculated in the second intersection calculation step onto a plane that passes through the rotation center point of the actual rotation axis and that is orthogonal to an axial unit vector for the rotation axis that passes through the rotation center point of the ideal rotation axis in an axial direction of the ideal rotation axis in the machine coordinate system or the workpiece coordinate system.
